(19) United States
(12) Patent Application Publication
(10) Pub. No.: US 2014/0124399 A1
(43) Pub. Date: May 8, 2014

(54) Water Resistant Adhesive for Beverage Labels

(71) Applicants: Graham Yeadon, Marbach (CH); Huig Van Der Bent, Katwijk Aan Zee (NL); Jos Van Noort, Leiden (NL); Harald Becker, Horn (CH); Edwin Van Delft, Oegstgeest (NL)

(72) Inventors: Graham Yeadon, Marbach (CH); Huig Van Der Bent, Katwijk Aan Zee (NL); Jos Van Noort, Leiden (NL); Harald Becker, Horn (CH); Edwin Van Delft, Oegstgeest (NL)

(73) Assignee: Avery Dennison Corporation, Pasadena, CA (US)

(21) Appl. No.: 14/131,023

(22) PCT Filed: Jul. 5, 2012
(86) PCT No.: PCT/US12/45489

§ 371 Date: Jan. 6, 2014

Related U.S. Application Data
(60) Provisional application No. 61/504,360, filed on Jul. 5, 2011.

(51) Int. Cl. C09J 133/08; C09J 7/02; B65D 25/20

(52) U.S. Cl. CPC C09J 133/08; B65D 25/205; C09J 7/0217
USPC 206/459.5; 428/355 AC; 526/318.44; 524/561; 156/332

(57) ABSTRACT

Various adhesives are described that are resistant to relatively hot aqueous washing solutions and particularly to hot caustic solutions used in bottle washing applications. The adhesives are used to adhere polymeric labels to containers such as beverage bottles and thereby enable the labeled bottles to be subjected to multiple washing operations without label removal or debonding.

### CROSS REFERENCE TO RELATED APPLICATIONS

The present application claims the benefit of U.S. Provisional Patent Application No. 61/504,360 filed Jul. 5, 2011, which is incorporated herein by reference in its entirety.

### FIELD

The present subject matter relates to pressure sensitive adhesive compositions used with polymeric labels that can withstand multiple washing cycles without debonding failure.

### BACKGROUND

Most re-useable beverage containers, especially beer bottles, are currently labeled with product name and consumer information using paper labels applied with an initially wet adhesive. After use of the container, the labels are removed in a washing process which is typically performed at 80° C. in an aqueous 2% sodium hydroxide solution for at least several minutes and in certain applications for several hours, before refilling and re-labeling. These conditions are widely used in industry since such conditions tend to sterilize the washed items.

Much development activity has been undertaken to develop filmic or polymeric labels for re-useable beverage containers similar to those using paper labels because the enhanced printing and appearance resulting from filmic labels is thought to promote beverage sales. However, such efforts have experienced difficulty. Even though filmic labels may be resistant to caustic washing solutions, such labels are still prone to label separation or removal due to the effect of the caustic washing solution on the label adhesive.

A small number of re-usable beverage containers receive direct printing and do not require re-labeling when being refilled. However, these are more expensive to produce and have the lowest print quality.

Accordingly, a need remains for a filmic label assembly including adhesive which is resistant to washing environments and thus could be used for at least several wash and filling cycles. Use of such label assemblies would enable improved print quality over printed containers without re-labeling after every wash.

### SUMMARY

The difficulties and drawbacks associated with previously known labels and methods are addressed in the present adhesive compositions, label assemblies, labeled containers, and methods.

In one aspect, the present subject matter provides an acrylic polymer adapted for incorporation in an adhesive formulation that is resistant to aqueous environments. The acrylic polymer comprises, prior to polymerization at least two (meth)acrylic monomers. After polymerization of the at least two (meth)acrylic monomers, the resulting acrylic polymer exhibits a glass transition temperature (Tg) of from about −70° C. to about −10° C.

In another aspect, the present subject matter provides an acrylic pressure sensitive adhesive that is resistant to aqueous environments. The adhesive comprises an acrylic polymer which exhibits a glass transition temperature (Tg) of from about −70° C. to about −10° C. The adhesive may also comprise at least one agent selected from the group consisting of a tackifier, a plasticizer, a filler, and additive, and combinations thereof.

In yet another aspect, the present subject matter also provides a label assembly adapted for re-use and which is resistant to aqueous environments. The label assembly comprises a polymeric film defining a first face and an oppositely directed second face. The label assembly also comprises a layer of an acrylic pressure sensitive adhesive comprising an acrylic polymer which exhibits a glass transition temperature (Tg) of from about −70° C. to about −10° C., disposed on the polymeric film.

In still another aspect, the present subject matter provides a labeled container that is resistant to aqueous environments. The container comprises a container formed from one of glass and plastic. The container defines an exterior surface. The labeled container also comprises a layer of an acrylic pressure sensitive adhesive comprising an acrylic polymer which exhibits a glass transition temperature (Tg) of from about −70° C. to about −10° C. The layer is disposed on the exterior surface of the container. The labeled container also comprises a label including a polymeric film disposed on the layer of the acrylic pressure sensitive adhesive.

In yet another aspect, the present subject matter provides a method of forming a labeled container which is resistant to aqueous environments. The method comprises providing a container formed from one of glass and plastic. The container defines an exterior surface. The method also comprises providing a label including a polymeric film. The method also comprises providing an acrylic pressure sensitive adhesive comprising an acrylic polymer which exhibits a glass transition temperature (Tg) of from about −70° C. to about −10° C. The method additionally comprises coating at least one of a region of the exterior surface of the container and the label with the adhesive to thereby form a layer of the adhesive. And, the method also comprises contacting the label with the exterior surface of the container such that the layer of the adhesive is disposed therebetween to thereby form the labeled container.

As will be realized, the subject matter is capable of other and different embodiments and its several details are capable of modifications in various respects, all without departing from the subject matter. Accordingly, the drawings and description are to be regarded as illustrative and not restrictive.

### DETAILED DESCRIPTION OF THE EMBODIMENTS

The present subject matter provides a class of adhesives that when used in conjunction with polymeric labels applied to glass or polymeric containers, are resistant to hot aqueous washing environments. In particular, the preferred embodiment adhesives are resistant to hot alkali washing environments. In view of the unique properties and resistance characteristics of the adhesives, the adhesives are particularly well suited for re-usable labeling applications. In one aspect, the present subject matter provides adhesives uniquely suited for re-usable labels. In another aspect, the subject matter provides labels including the unique adhesives. In yet another aspect, the subject matter provides labeled containers using the adhesives. And, in still another aspect, the subject matter includes various processes of using the adhesives. These and other details are as follows.

In one version of the subject matter, an overlam construction is provided. The overlam construction preferably includes a clear or substantially optically transparent film. The overlam construction covers a label which may or may not include a wash resistant adhesive, adhered to a container or other article. Preferably, the overlam construction includes a layer of a wash resistant adhesive. The overlam construction can cover up to 100% of the exterior surface area of the container or article. The overlam construction may in certain embodiments, be in the form of a shrinkable sleeve or preformed tube that is sized and shaped for subsequent attachment to the container or article of interest. Preferably, the overlam construction, e.g. the sleeve or tube, includes a layer or region(s) of the wash resistant adhesive, such as coated along an interior face of the sleeve or tube.

### Adhesives

The preferred embodiment adhesives comprise one or more acrylic polymers. The acrylic polymer adhesives are prepared by copolymerizing monomers including two or more (meth)acrylate monomers. Examples of preferred (meth)acrylate monomers are set forth below in Table 1.

TABLE 1
Preferred Acrylate Monomers

| Monomer | Abbreviation | No. of C Atoms |
|---|---|---|
| octyl acrylate | (OA) | C₈ |
| butyl acrylate | (BA) | C₄ |
| ethyl acrylate | (EA) | C₂ |
| methyl acrylate | (MA) | C₁ |
| lauryl methacrylate | (LMA) | C₁₂ |
| octyl methacrylate | (OMA) | C₈ |
| butyl methacrylate | (BMA) | C₄ |
| ethyl methacrylate | (EMA) | C₂ |
| methyl methacrylate | (MMA) | C₁ |
| other cyclic and heterocyclic | | |
| (meth)acrylates | | |

In Table 1, the C designations indicate the number of carbon atoms in the alkyl chain. When the chain includes more than two carbon atoms, then the monomer can be in the form of different isomers, e.g., butyl acrylate can be in the form of t-butyl acrylate or iso-butyl acrylate. Thus, for each such noted monomer, the subject matter includes all isomers of the monomer.

Other monomers can optionally be used in forming the acrylic polymers. These are divided into non-functional and functional monomers. “Functional monomers” as used herein refer to monomers having acid or hydroxy groups which allow crosslinking regardless of whether the acrylic polymers are crosslinked. The bulk of the adhesive is formed by “non-functional monomers.” Typically, the non-functional monomers contribute less than 10% of the total amount of acid and hydroxy groups in the monomeric mixture.

Preferred non-functional monomers are represented by the monomers in Table 2.

TABLE 2
Preferred Non-Functional Monomers

| Monomer | Abbreviation |
|---|---|
| vinyl acetate | (VA) |
| styrene | (Sty) |
| di-alkyl maleate | |
| di-alkyl fumarate | |

It will be appreciated that in no fashion is the subject matter limited to the use of these non-functional monomers. Instead, the acrylic polymers used in the preferred embodiment adhesives can include a wide array of other non-functional monomers.

Preferred functional monomers are represented by the monomers in Table 3.

TABLE 3
Preferred Functional Monomers

| Monomer | Abbreviation |
|---|---|
| acrylic acid | (AA) |
| methacrylic acid | (MA) |
| hydroxy alkyl meth(acrylate) | |

Similarly, it will also be understood that in no manner is the subject matter limited to the use of these preferred functional monomers. Instead, the acrylic polymers can include a wide array of other functional monomers.

Preferably, the adhesive is resistant to hydrolysis in a hot caustic solution, typically 2% sodium hydroxide at 80° C. The degree of hydrolysis resistance that is necessary is however, minimal because typically, only the edge of a layer of the adhesive is exposed to the caustic solution. In view of this, it is contemplated that nearly all acrylic adhesives could potentially be used so long as they exhibited the features described herein. However, the amount of vinyl acetate and methyl acrylate should be relatively low because copolymers containing these monomers are suspectible to hydrolysis. Most preferably, the preferred adhesive includes less than 10% by weight of one or more monomers that hydrolyze upon exposure to hot aqueous environments and particularly to hot alkali environments. As noted, examples of such monomers include, but are not limited to vinyl acetate and methyl acrylate.

Preferably, the acrylic polymer used in the adhesives described herein is formed from a particular combination of monomers. Preferably, the monomers are selected and used in proportions such that the resulting acrylic polymer has a glass transition temperature (Tg) of from about −70° C. to about −10° C.

In certain embodiments, the acrylic polymer also preferably includes particular proportions of functional monomers and non-functional monomers. Preferably, the acrylic polymers used in the preferred embodiment adhesives include from about 0.1% to about 10% by weight of functional monomers. If greater amounts of functional monomers are used, the resulting adhesives become relatively costly. In addition, if greater amounts of functional monomers are used, the resulting adhesives tend to react with hydroxy groups in a washing solution. Hydrolysis of the adhesive is undesirable because adhesives tend to whiten, thereby detrimentally impacting appearance of a labeled container. In many cases, a reduction in adhesive strength also occurs. Preferably, the acrylic polymers and/or the adhesive formulation includes a majority proportion of non-functional monomers. As previously noted, non-functional monomers have low amounts of acid or hydroxy groups.

The acrylic polymers used in the preferred embodiment adhesives may be crosslinked, or may not be crosslinked. Typically, the polymers are crosslinked. A variety of techniques can be used to crosslink the polymers. For example, one or more crosslinking agents can be included in the polymerization process. The polymers can also be crosslinked by exposure to electromagnetic radiation, or by heating.

The preferred embodiment adhesives comprise one or more acrylic polymers as described herein. The preferred adhesives may also comprise one or more tackifiers, one or more plasticizers, one or more fillers, and one or more additives and/or other agents. Appropriate blending of these components with the acrylic polymers described herein produces preferred embodiment acrylic pressure sensitive adhesives.

Although not wishing to be bound to any particular adhesive type or manner of forming, the preferred embodiment adhesives are solvent-based adhesives.

### Labels

The present subject matter also includes labels and label assemblies that comprise a layer or coating of the preferred embodiment acrylic pressure sensitive adhesive. The label may be of a single layer or unitary construction. Alternatively, the label may include multiple layers. Preferably, the label comprises at least one layer including a polymeric material selected from the following: biaxially oriented polypropylene (BOPP), polypropylene (PP), polyethylene (PE), polyester, polystyrene (PS), polycarbonate (PC), polymethacrylate (PM), and combinations thereof. BOPP is preferred. The label may be transparent or may have some degree of opacity, up to 100 percent, for example, white.

The label is preferably durable and resistant to tearing, punctures, breaks, fractures, and the like. Thus, the label material preferably exhibits sufficient strength and/or durability such that the label is resistant to damage during shipping, inventory stocking, use by consumers, and washing.

Generally, the adhesive is applied to a face of a polymeric layer or film. Conventional coating techniques can be utilized. Typically, the layer of adhesive is continuous and generally uniform over the face or area of the label film. However, the subject matter includes pattern coating the adhesive such that the layer is discontinuous and contains one or more regions devoid or free of adhesive.

As will be appreciated, typically, labels include various decorative or informational printing, designs, or indicia along one or both of their faces. The labels described herein generally include at least one print region visible on or along their outer face.

### Labeled Containers

The subject matter also includes containers or other articles that have one or more labels adhered to the container by the preferred embodiment adhesives described herein. Although it is contemplated that the primary application of the preferred embodiment adhesives will be for beverage bottles, it will be understood that in no way is the subject matter limited to such. Instead, the containers include crates, bottle receptacles, holding frames, and packaging assemblies. Generally, any article which may receive a label and which undergoes washing such as by exposure to a hot caustic solution, constitutes a “labeled container” for purposes of describing the preferred embodiments.

The containers are typically in the form of bottles for beverages. The containers are typically formed from glass or polymeric materials such as plastics.

The containers (glass or plastic) may be coated or include one or more layers along their exterior or interior faces. The preferred embodiment adhesives may be applied or bond directly to the coating layer(s), or bond to the glass or polymeric material of the container wall. Although containers such as beverage containers typically include a wide array of coatings, many of these coatings remain with the container after washing, and are thus referred to herein as “caustic resistant coatings.”

### Methods

The methods of the present subject matter relate to forming re-usable label assemblies of at least one polymeric layer and an adhesive layer, using such label assemblies such as by adhering to a container, and methods of preparing labeled containers by use of the label assemblies.

A preferred embodiment label assembly is prepared by providing at least one polymeric film and applying the preferred acrylic pressure sensitive adhesive to the film. The polymeric film is as described herein. Similarly, the acrylic pressure sensitive adhesive is also as described herein.

The preferred label assemblies are utilized by application of one or more labels to a container. The label is typically adhered to a region along the exterior of the container or item to be labeled. Depending upon the characteristics of the adhesive, it may be preferred to adhere the adhesive to the container at an elevated temperature.

Labeled containers can be prepared by adhesively applying the preferred label assemblies to the containers. High speed automated processes can be used. As described herein, the labeled containers can be subjected to multiple washing operations using hot caustic washing solutions without label debonding.

### Additional Aspects

The present subject matter also includes additional aspects such as utilizing tracking and/or monitoring technologies in conjunction with the adhesives, labels, and/or labeled containers. For example, RFID technology and in particular, one or more RFID components, can be incorporated in a wash resistant adhesive construction so that parameters such as label presence, number of wash cycles, information for consumers including marketing information, brand information, and the like, can be monitored and included in the label which will remain attached to the article for a substantial period of time.

Details as to RFID technology components used therein, and methods and strategies related thereto, are described in one or more of the following patents: U.S. Pat. No. 7,212,127; 7,479,888; 7,088,248; 7,307,527; 7,170,415; 7,298,343; 7,629,888; 7,368,032; 7,361,251; 7,701,352; 7,224,278; 7,555,826; 7,120,987; 6,867,983; 5,982,284; 7,782,212; 7,842,152; and 7,832,133.

### Testing

In order to further investigate the preferred embodiment adhesives of the subject matter, several trials were undertaken as follows.

Two pressure sensitive adhesives were prepared as set forth below in Table 4:

TABLE 4
Adhesive Formulations Tested

| Monomer | MT-1 | MT-7 |
|---|---|---|
| 2-ethylhexyl acrylate | 73.9% | 77.9% |
| butyl acrylate | — | 14.1% |
| vinyl acetate | 20.0% | 4.2% |
| acrylic acid | 6.0% | 3.8% |

The adhesive designated as MT-1 was unacceptable while the adhesive MT-7 was suitable for adhering a label to a container exterior and then subjecting the labeled container to multiple washing cycles using a hot caustic washing solution. It is believed that the MT-1 formulation was unacceptable due to the relatively high content, i.e., greater than 10%, of the monomer vinyl acetate.

Although not wishing to be limited to any particular number of washing cycles, it is contemplated that containers labeled with the preferred embodiment labels described herein using the preferred embodiment acrylic pressure sensitive adhesives can be subjected to at least 10 washing cycles, more preferably 15 washing cycles, more preferably 20 washing cycles, more preferably 25 washing cycles, and most preferably 30 washing cycles without debonding of the label from the container. Thus, the terms “resistant to aqueous environments” and “resistant to hot alkali environments” refer to a labeled container being exposed to these numbers of washing cycles without label debonding. A typical washing cycle as noted herein is performed by washing using an aqueous solution of 2% sodium hydroxide at 80° C. for a time period of from several minutes up to several hours.

Many other benefits will no doubt become apparent from future application and development of this technology.

All patents, applications, and articles noted herein are hereby incorporated by reference in their entirety.

As described hereinabove, the present subject matter solves many problems associated with previous type devices. However, it will be appreciated that various changes in the details, materials and arrangements of components, which have been herein described and illustrated in order to explain the nature of the subject matter, may be made by those skilled in the art without departing from the principle and scope of the subject matter, as expressed in the appended claims.

1. An acrylic polymer adapted for incorporation in an adhesive formulation that is resistant to aqueous environments, the acrylic polymer comprising, prior to polymerization:
at least two (meth)acrylic monomers;
wherein after polymerization of the at least two (meth)acrylic monomers, the resulting acrylic polymer exhibits a glass transition temperature (Tg) of from about −70° C. to about −10° C.

2. The acrylic polymer of claim 1 wherein the acrylic polymer further comprises, prior to polymerization, at least one functional monomer.

3. The acrylic polymer of claim 2 wherein the amount of the functional monomer ranges from about 0.1% to about 10%.

4. The acrylic polymer of claim 1 wherein the acrylic polymer further comprises, prior to polymerization, at least one non-functional monomer.

5. An acrylic pressure sensitive adhesive that is resistant to aqueous environments, the adhesive comprising:
an acrylic polymer which exhibits a glass transition temperature (Tg) of from about −70° C. to about −10° C.;
at least one agent selected from the group consisting of a tackifier, a plasticizer, a filler, an additive, and combinations thereof.

6. The acrylic adhesive of claim 5 wherein the adhesive is resistant to hot alkali environments.

7. A label assembly adapted for re-use and which is resistant to aqueous environments, the label assembly comprising:
a polymeric film defining a first face and an oppositely directed second face;
a layer of an acrylic pressure sensitive adhesive comprising an acrylic polymer which exhibits a glass transition temperature (Tg) of from about −70° C. to about −10° C., disposed on the polymeric film.

8. The label assembly of claim 7 wherein the polymeric film includes a material selected from the group consisting of biaxially oriented polypropylene (BOPP), polypropylene (PP), polyethylene (PE), polyester, polystyrene (PS), polycarbonate (PC), polymethacrylate (PM), and combinations thereof.

9. The label assembly of claim 7 wherein the polymeric film is biaxially oriented polypropylene (BOPP).

10. The label assembly of claim 7 wherein the label is resistant to hot alkali environments.

11. The label assembly of claim 7 wherein the polymeric film is transparent or may have opacity.

12. The label assembly of claim 7 wherein the polymeric film is in the form of a shrinkable sleeve or tube.

13. The label assembly of claim 7 further comprising:
an RFID component included in the label assembly.

14. A labeled container that is resistant to aqueous environments, the container comprising:
a container formed from one of glass and plastic, the container defining an exterior surface;
a layer of an acrylic pressure sensitive adhesive comprising an acrylic polymer which exhibits a glass transition temperature (Tg) of from about −70° C. to about −10° C., the layer disposed on the exterior surface of the container; and
a label including a polymeric film disposed on the layer of the acrylic pressure sensitive adhesive.

15. The labeled container of claim 14 wherein the label defines an inner face directed toward the layer of the acrylic pressure sensitive adhesive and an oppositely directed outer face, the label further including a print region disposed on the outer face.

16. The labeled container of claim 14 wherein the labeled container is resistant to hot alkali environments.

17. The labeled container of claim 14 wherein the polymeric film includes a material selected from the group consisting of biaxially oriented polypropylene (BOPP), polypropylene (PP), polyethylene (PE), polyester, polystyrene (PS), polycarbonate (PC), polymethacrylate (PM), and combinations thereof.

18. The labeled container of claim 14 wherein the polymeric film is biaxially oriented polypropylene (BOPP).

19. The labeled container of claim 14 wherein the polymeric film is transparent or may have opacity.

20. The labeled container of claim 14 wherein the polymeric film is in the form of a shrinkable sleeve or tube.

21. The labeled container of claim 14 wherein the label further includes an RFID component.

22. The labeled container of claim 14 further comprising:
a secondary label disposed on the container;
wherein the polymeric least partially covers the secondary label.

23. A method of forming a labeled container which is resistant to aqueous environments, the method comprising:
providing a container formed from one of glass and plastic, the container defining an exterior surface;
providing a label including a polymeric film;
providing an acrylic pressure sensitive adhesive comprising an acrylic polymer which exhibits a glass transition temperature (Tg) of from about −70° C. to about −10° C.;
coating at least one of a region of the exterior surface of the container and the label with the adhesive to thereby form a layer of the adhesive; and
contacting the label with the exterior surface of the container such that the layer of the adhesive is disposed therebetween to thereby form the labeled container.

24. The method of claim 23 wherein the labeled container is resistant to hot alkali environments.
